(19) United States
(12) Patent Application Publication
(10) Pub. No.: US 2007/0160086 A1
(43) Pub. Date: Jul. 12, 2007

(54) VoIP phone with a receiving module for receiving data stored in a portable memory device and a VoIP module

(75) Inventors: Yung-Lang Huang, Taipei City (TW); Yu-Cheng Tu, Taipei City (TW); Tsung-Yu Ma, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/649,757

(22) Filed: Jan. 5, 2007

(30) Foreign Application Priority Data
Jan. 6, 2006 (TW) 095100666

(51) Int. Cl. H04M 1/00

(52) U.S. Cl. 370/493; 379/352; 379/88.19

(57) ABSTRACT

A Voice over Internet Protocol phone (VoIP phone) includes a VoIP module coupled to an external network, a receiving module for receiving data stored in a portable memory device, and a control means coupled to the VoIP module and the receiving module for controlling the VoIP module according to the data stored in the portable memory device received by the receiving module. The VoIP phone can be utilized in public places without risk of compromising the security of personal information.

### BACKGROUND OF THE INVENTION

1. Field of the Invention

The present invention relates to a voice over Internet protocol (VoIP) phone, and more particularly, to a VoIP phone with a receiving module for receiving data stored in a portable memory device and a VoIP module.

2. Description of the Prior Art

The popularity of personal computers (PCs) and the Internet has inspired a new type of communication device: a network phone (such as a VoIP phone). The network phone provides an alternate selection for users to communicate with each other instead of utilizing a traditional phone. Generally, the network phone utilizes a specific program run on the PC to provide the above-mentioned communication function through the Internet. Therefore, users are not required to utilize a traditional telecommunications (telecom) system. Obviously, the network phone saves users money because users pay a low price charged by the Internet service provider rather than the comparably higher price charged by the telecom system provider.

Unfortunately, problems exist with network phones. For example, the network phone is a PC-based architecture, therefore, users are required to input user information such as a user log in account, a password, etc. Additionally, payment information is required such as a credit card number and a stored value access number. Finally, users of the network phone are required to input a destination telephone number (i.e., the number to be called) before executing the network phone communication function. User must input all the related information through a computer interface. Certain public places are inconvenient to set up a computer for providing a network phone service. Therefore, this raises a problem with the network phone application.

### SUMMARY OF THE INVENTION

An embodiment of the claimed invention discloses a voice over Internet Protocol (VoIP) phone with a receiving module for receiving data stored in a portable memory device and a VoIP module. The VoIP phone comprises a VoIP module for providing Internet connectivity; a receiving module for receiving data stored in a portable memory device; and a control means for controlling the VoIP module according to the data stored in the portable memory device received by the receiving module. Another embodiment of the claimed invention discloses a method of controlling a VoIP phone according to data stored in a portable memory device. The method comprises the following steps: a receiving module of the VoIP phone receiving the data stored in the portable memory device; the VoIP phone transmitting the data stored in the portable memory device to a service system; the service system transmitting a data to the VoIP phone after receiving the data transmitted from the VoIP phone; and controlling the VoIP phone according to the data transmitted from the service system. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an external diagram of a voice over Internet protocol (VoIP) phone of the present invention.

FIG. 2 illustrates a functional block diagram of a VoIP phone of the present invention.

FIG. 3 illustrates a flowchart of controlling a VoIP phone according to data stored in a portable memory device according to the present invention.

### DETAILED DESCRIPTION

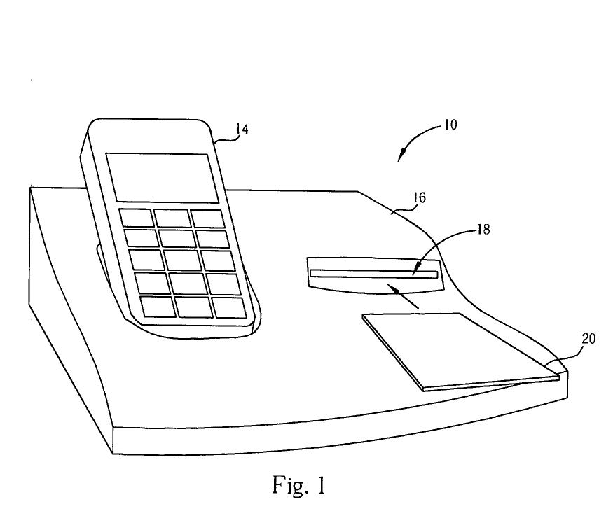

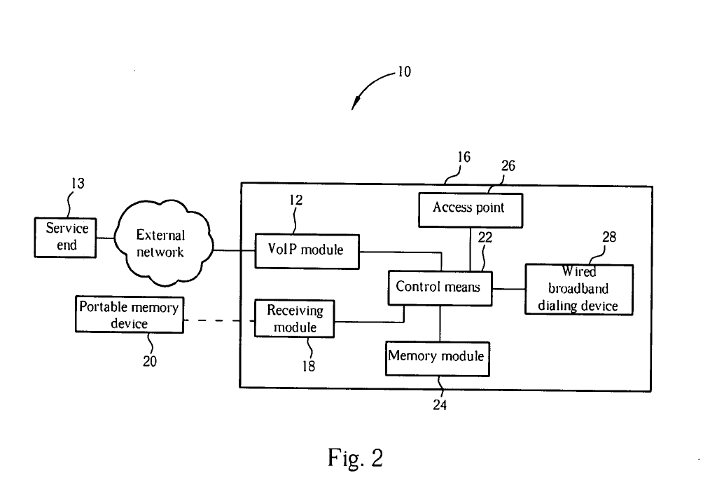

Please refer to FIG. 1 and FIG. 2. FIG. 1 illustrates an external diagram of a voice over Internet protocol (VoIP) phone 10 of the present invention. FIG. 2 illustrates a functional block diagram of a VoIP phone 10 of the present invention. The VoIP phone 10 includes a VoIP module 12 coupled to an external network for providing an Internet phone functions, wherein the connection to the external network can be in a wired transmission manner or a wireless transmission manner. The VoIP module 12 is coupled to a service system 13 through the external network, the service system 13 can be an internal phone service system or a financial service system. The VoIP phone 10 includes a handset for dialing numbers and for carrying out conversations. The handset 14 and the VoIP phone 10 can transmit audio signals in a wired or wireless manner.

The VoIP phone 10 further includes a housing 16, and a receiving module 18 installed within the housing 16 for receiving data stored in an external portable memory device 20. The receiving module 18 can be a smart card reader for reading data stored in a smart card. The smart card reader can be a contactless smart card reader for reading data stored in a contactless smart card, for example a reader of a radio frequency identification technology is utilized for reading data stored in a contactless smart card having a radio frequency identification chip; the smart card reader can be a contact smart card reader for reading data stored in a contact smart card, for example a chip card or a magnetic card. The receiving module 18 can also be a memory card reader for reading data stored in a memory card, or a memory module that has a universal serial bus (USB) interface utilized for reading data stored in a portable disc with an USB interface. The VoIP phone 10 further includes a control means 22 installed within the housing 16 for controlling the VoIP module 12 according to the data stored in the portable memory device 20 received by the receiving module 12. The VoIP phone 10 further includes a memory module 24 for storing a phone book data stored in the portable memory device 20 received by the receiving module 18. Furthermore, the VoIP phone 10 further includes an access point (AP) 26 for providing a function of bridging a wired local area network (LAN) and a wireless LAN, and a wired broadband dialing device 28 that can be an asymmetrical digital subscriber line (ADSL), an integrated service digital network (ISDN), or a cable modem is utilized for providing wired broadband access.

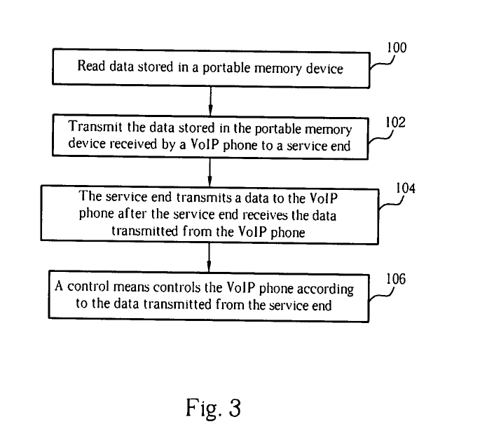

Please refer to FIG. 3. FIG. 3 illustrates a flowchart of controlling the VoIP phone 10 according to the data stored in the portable memory device 20 according to the embodiment of the present invention. The method the embodiment of the present invention includes the following steps:
Step 100: the receiving module 18 of the VoIP phone 10 reads the data stored in the portable memory device 20;
Step 102: the VoIP phone 10 transmits the data stored in the portable memory device 20 received by the VoIP phone 10 to the service system 13;
Step 104: the service system 13 transmits a data to the VoIP phone after the service system 13 receives the data transmitted from the VoIP phone 10;
Step 106: the control means 22 controls the VoIP phone 10 according to the data transmitted from the service system 13.

The following explanation provides a more detailed description of the above-mentioned steps. Information such as user permission data, stored value data, phone book data, or personal settings of the VoIP module 12 can be stored within the portable memory device 20, therefore the portable memory device 20 can be personal, when the personal portable memory device 20 is inserted into the receiving module 18 of the VoIP phone 10, in another words the settings of the VoIP phone 10 will be changed to the settings of a specific user. The receiving module 18 of the VoIP phone 10 can receive the data stored in the portable memory device 20 through a contact or contactless manner, and the personal data, for example, a phone book, stored in the portable memory device 20 received by the receiving module 18 can be stored into the memory module 24 for providing related information, such as the phone book data, to perform a dialing action for the user when the user wishes to make a call.

Also, the control means 22 will control the VoIP module 12 to transmit the data stored in the portable memory device 20 received by the receiving module 18 to the service system 13, for example, the control means 22 is capable of controlling the VoIP module 12 to transmit a user permission data such as log in account and password, stored in the portable memory device 20 received by the receiving module 18 to an Internet phone service system, and a conversation function of the VoIP module 12 is activated according to a certified data transmitted from the Internet phone service system.

In another words, the user successfully logs on to the Internet phone service system, and the Internet phone service system verifies that the VoIP phone 10 end can utilize the Internet phone services provided, thus the user can utilize the VoIP module 12 of the VoIP phone 10 to make calls; or the control means 22 is capable of controlling the VoIP module 12 to transmit a financial data stored in the portable memory device 20 received by the receiving module 18 to a financial service system, and the conversation function of the VoIP module 12 is activated according to an authorized data transmitted from the financial service system, which means that the control means 22 connects to the financial service system for verification in order to obtain an authorization mechanism; or the control means 22 can directly activate the conversation function of the VoIP module 12 according to the data stored in the portable memory device 20 received by the receiving module 18, which means that the authorization mechanism is obtained through off-line verification. Later, the user can utilize the VoIP module 12 of the VoIP phone 10 to make an Internet phone call hence the function of Internet network communication is achieved. After the Internet phone conversation has ended, credit stored in the portable memory device 20 is debited according to the user status (i.e., conversation status) of the VoIP module 12 of the VoIP phone 10, the debit mechanism can be the control means 22 directly performs an off-line debit action on the portable memory device 20 according to the user status of the VoIP module 12; or when the conversation has ended, the VoIP module 12 transmits a transaction data of a corresponding conversation content to the service system 13, and then the service system 13 will perform an on-line debit action on the portable memory device 20.

Similarly, the above-mentioned method of controlling the VoIP module 12 according to the data stored in the portable memory device 20 received by the receiving module 18 can be applied to control the AP 26 or the wired broadband dialing device 28. In other words, the data stored in the portable memory device 20 received by the receiving module 18 is utilized to log in on-line or to execute the stored value debit required to provide the wired broadband access function.

In comparison to the conventional VoIP phone, the VoIP phone combines the receiving module of the portable memory device and the VoIP module, therefore in utilizing the method of the VoIP phone receiving the data stored in the portable memory device, the VoIP phone is utilized to realize the functions of auto log-in to the Internet phone service system, stored value debit, and downloading personal data (e.g., a phone book data), also as user permission data (e.g., log-in account and password), debit related information (e.g., credit number and stored value authorization number), and phone book data are being stored within the portable memory device, thus the personal data can be portable and downloaded to a VoIP phone when the VoIP phone is being utilized. In this way, security of personal information can be increased without putting personal information at risk of being compromised when the VoIP phone is being utilized to make calls at public places, hence the present invention overcomes the defect of the conventional Internet phone application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voice over Internet Protocol (VoIP) phone with a receiving module for receiving data stored in a portable memory device and a VoIP module, the VoIP phone comprising:
a VoIP module coupled to an external network for providing Internet connectivity;
a receiving module for receiving data stored in a portable memory device; and
a control means coupled to the VoIP module and the receiving module for controlling the VoIP module according to the data stored in the portable memory device received by the receiving module.

2. The VoIP phone of claim 1 further comprising a wireless network bridge for bridging a wired local area network (LAN) and a wireless LAN.

3. The VoIP phone of claim 1 further comprising a wired broadband dialing device for providing wired broadband access.

4. The VoIP phone of claim 3 wherein the wired broadband dialing device is an asymmetrical digital subscriber line (ADSL) modem.

5. The VoIP phone of claim 3 wherein the wired broadband dialing device is an integrated service digital network (ISDN) modem.

6. The VoIP phone of claim 3 wherein the wired broadband dialing device is a cable modem.

7. The VoIP phone of claim 1 wherein the receiving module is a smart card reader for receiving data stored in a smart card.

8. The VoIP phone of claim 7 wherein the receiving module is a contactless smart card reader for reading data stored a non-contact smart card.

9. The VoIP phone of claim 7 wherein the receiving module is a contact smart card reader for reading data stored in a contact smart card.

10. The VoIP phone of claim 1 wherein the receiving module is a memory card reader for reading data stored in a memory card.

11. The VoIP phone of claim 1 wherein the control means is utilized for activating a conversation function of the VoIP phone according to the data stored in the portable memory device received by the receiving module.

12. The VoIP phone of claim 1 wherein the control means is utilized for controlling the VoIP module to transmit user permission data stored in the portable memory device received by the receiving module to an Internet phone service system, and for activating the conversation function of the VoIP module according to a certified data transmitted from the Internet phone service system.

13. The VoIP phone of claim 11 wherein the control means is utilized for controlling the VoIP phone to transmit financial data stored in the portable memory device received by the receiving module to a financial service system, and for activating the conversation function of the VoIP module according to certified data transmitted from the financial service system.

14. A method of controlling a VoIP phone according to data stored in a portable memory device, the method comprising:
a receiving module of the VoIP phone receiving the data stored in the portable memory device;
the VoIP phone transmitting the data stored in the portable memory device to a service system;
the service system transmitting a data to the VoIP phone after receiving the data transmitted from the VoIP phone; and
using the VoIP phone according to the data transmitted from the service system.

15. The method of claim 14 wherein the step of a receiving module of the VoIP phone receiving the data stored in the portable memory device comprises a receiving module of the VoIP phone receiving the data stored in the portable memory device in a contact manner.

16. The method of claim 14 wherein the step of a receiving module of the VoIP phone receiving the data stored in the portable memory device comprises a receiving module of the VoIP phone receiving the data stored in the portable memory device in a contactless manner.

17. The method of claim 14 wherein the step of the VoIP phone transmitting the data stored in the portable memory device to a service system comprises the VoIP phone through Internet network transmitting the data stored in the portable memory device to a service system.

18. The method of claim 14 wherein the step of the VoIP phone transmitting the data stored in the portable memory device to a service system comprises the VoIP phone transmitting a user permission data stored in the portable memory device received by the VoIP phone to a service system, the step of the service system transmitting a data to the VoIP phone after receiving the data transmitted from the VoIP phone comprises the service system transmitting a certified data back to the VoIP phone after receiving the user permission data transmitted from the VoIP phone, and the step of controlling the VoIP phone according to the data transmitted from the service system comprises activating a conversation function of the VoIP phone according to the certified data transmitted from the service system.

19. The method of claim 14 wherein the step of the VoIP phone transmitting the data stored in the portable memory device to a service system comprises the VoIP transmitting financial data stored in the portable memory device received by the VoIP phone to a service system, the step of the service system transmitting a data to the VoIP phone after receiving the data transmitted from the VoIP phone comprises the service system transmitting a certified data back to the VoIP phone after receiving the financial data transmitted from the VoIP phone, and the step of controlling the VoIP phone according to the data transmitted from the service system comprises activating a conversation function of the VoIP phone according to the certified data transmitted from the service system.

20. The method of claim 14 wherein the step of the VoIP phone transmitting the data stored in the portable memory device to a service system comprises the VoIP transmitting a user permission data stored in the portable memory device received by the VoIP phone to a service system, the step of the service system transmitting a data to the VoIP phone after receiving the data transmitted from the VoIP phone comprises the service system transmitting a certified data back to the VoIP phone after receiving the user permission data transmitted from the VoIP phone, and the step of controlling the VoIP phone according to the data transmitted from the service system comprises activating a function of bridging a wired local area network (LAN) and a wireless LAN or a function of a wireless broadband access of the VoIP phone according to the certified data transmitted from the service system.

21. The method of claim 14 wherein the step of the VoIP phone transmitting the data stored in the portable memory device to a service system comprises the VoIP transmitting a financial data stored in the portable memory device received by the VoIP phone to a service system, the step of the service system transmitting a data to the VoIP phone after receiving the data transmitted from the VoIP phone comprises the service system transmitting a certified data back to the VoIP phone after receiving the financial data transmitted from the VoIP phone, and the step of controlling the VoIP phone according to the data transmitted from the service system comprises activating a function of bridging a wired local area network (LAN) and a wireless LAN or a function of a wireless broadband access of the VoIP phone according to the certified data transmitted from the service system.
